(19) United States
(12) Patent Application Publication
(10) Pub. No.: US 2023/0028740 A1
(43) Pub. Date: Jan. 26, 2023

(54) APPARATUS, METHOD, AND RECORDING MEDIUM STORING COMMANDS FOR SUPPORTING PAYMENT

(71) Applicant: Bluewalnut Co., Ltd., Seoul (KR)

(72) Inventors: Chang Min PARK, Seoul (KR); Dai Suk JANG, Gyeonggi-do (KR)

(21) Appl. No.: 17/867,328

(22) Filed: Jul. 18, 2022

(30) Foreign Application Priority Data
Jul. 22, 2021 (KR) 10-2021-0096252
May 4, 2022 (KR) 10-2022-0055156

(51) Int. Cl. G06Q 30/06; G06Q 20/34

(52) U.S. Cl. CPC G06Q 30/0637; G06Q 20/34

(57) ABSTRACT

An apparatus according to the present disclosure may acquire connection information generated based on a resident registration number of the user and order information for an order of the user, may transmit the connection information to a card company server, may acquire first card information of the user determined based on the connection information, the first card information including one or more card replacement numbers, may transmit second card information to a terminal of the user, may acquire information indicating a first card used to pay for the order among one or more cards included in the second card information, may transmit a card replacement number for the first card to the card company server, may acquire approval information for approving payment for the order by the first card, and may pay for the order based on the approval information.

### CROSS-REFERENCE TO RELATED APPLICATION

This application is based upon and claims the benefit of priority from Korean Patent Application No. 10-2021-0096252, filed on Jul. 22, 2021, and Korean Patent Application No. 10-2022-0055156, filed on May 4, 2022, the entire contents of which are incorporated herein by reference.

### TECHNICAL FIELD

The present disclosure relates to a technology for supporting a user's payment.

### BACKGROUND

Due to the development of electronic commerce, various technologies for supporting payment of a user may exist. For example, when a separate payment service provider (e.g., an app card, etc.) registers a card from a user, and when the user requests a member store server for payment online, the payment may be supported.

However, when a card is newly issued by a card company, when the card registered with the payment service provider is no longer valid, or the like, there was a limitation that the user should manually regenerate or correct card information registered with the payment service provider. Further, in this case, the payment service provider should repeatedly perform a card validity determination operation and a card registration operation, thus increasing an operation burden. Furthermore, depending on the types of payment service providers supported by member stores, a user should register the user's card with all of multiple different payment service providers.

### SUMMARY

The present disclosure provides a technology for supporting a user's payment.

An aspect of the present disclosure may provide an apparatus for supporting a payment of a user in a card member store. The apparatus according the present disclosure may include: at least one processor; and at least one memory configured to store commands which, when executed by the at least one processor, cause the at least one processor to perform an operation, wherein the at least one processor is configured to, according to the commands, to perform: acquire, from a server of the card member store, connection information generated based on a resident registration number of the user and order information for an order of the user, transmit the connection information to a card company server, acquire first card information of the user determined based on the connection information from the card company server, the first card information including one or more card replacement numbers, each of the one or more card replacement numbers being a value generated based on a card number of each of one or more cards issued to the user, and the card number of each of the one or more cards being a value stored in the card company server at a time point of issuing of each of the one or more cards, transmit second card information generated based on the first card information to a terminal of the user, acquire, from the terminal of the user, information indicating a first card used to pay for the order among one or more cards included in the second card information, transmit a card replacement number for the first card to the card company server, acquire, from the card company server, approval information for approving payment for the order by the first card, and pay for the order based on the approval information.

In an embodiment, the connection information may be information uniquely assigned to the user.

In an embodiment, the connection information may be information generated to correspond one-to-one to the resident registration number of the user.

In an embodiment, each of the one or more card replacement numbers may be a value generated based on the card number of each of the one or more cards issued to the user with reference to a time point of transmitting the connection information to the card company server.

In an embodiment, each of the one or more card replacement numbers may be a value generated by encoding the card number of each of the one or more cards.

In an embodiment, the first card information may further include at least one among status information of each of the one or more cards, card image information of each of the one or more cards, and a first determination value for indicating whether a card password is set.

In an embodiment, the at least one processor may generate, based on the status information of each of the one or more cards, the second card information from which at least one of the one or more cards issued to the user are excluded.

In an embodiment, the at least one processor may transmit, when the card password is determined not to be set based on the first determination value, password registration-related information before transmitting the second card information to the terminal of the user.

In an embodiment, the at least one processor may transmit the connection information to the card company server with the card replacement number for the first card.

In an embodiment, the at least one processor may perform a validity determination operation for the connection information before transmitting the connection information to the card company server with the card replacement number for the first card, and the validity determination operation may be an operation for determining whether connection information acquired from the server of the card member store matches connection information to be transmitted to the card company server.

In an embodiment, the at least one processor may transmit the approval information, the connection information, and the order information to the server of the card member store to pay for the order.

Another aspect of the present disclosure may provide a method for supporting a payment of a user in a card member store. The method according to the present disclosure may be a method performed in an apparatus including at least one processor and at least one memory storing commands executed by the at least one processor. The method according to the present disclosure may include: acquiring, by the at least one processor, connection information generated based on a resident registration number of the user and order information for an order of the user from a server of the card member store; transmitting, by the at least one processor, the connection information to a card company server; acquiring, by the at least one processor, first card information of the user determined based on the connection information from the card company server, the first card information including one or more card replacement numbers, each of the one or more card replacement numbers being a value generated based on a card number of each of one or more cards issued to the user, and the card number of each of the one or more cards being a value stored in the card company server at a time point of issuing of each of the one or more cards; transmitting, by the at least one processor, second card information generated based on the first card information to a terminal of the user; acquiring, by the at least one processor, from the terminal of the user, information indicating a first card used to pay for the order among one or more cards included in the second card information; transmitting, by the at least one processor, a card replacement number for the first card to the card company server; acquiring, by the at least one processor, approval information for approving payment for the order by the first card from the card company server; and paying for the order by the at least one processor based on the approval information.

In an embodiment, the connection information may be information uniquely assigned to the user.

In an embodiment, the connection information may be information generated to correspond one-to-one to the resident registration number of the user.

In an embodiment, each of the one or more card replacement numbers may be a value generated based on the card number of each of the one or more cards issued to the user with reference to a time point of transmitting the connection information to the card company server.

In an embodiment, each of the one or more card replacement numbers may be a value generated by encoding the card number of each of the one or more cards.

In an embodiment, the first card information may further include at least one among status information of each of the one or more cards, card image information of each of the one or more cards, and a first determination value for indicating whether a card password is set.

In an embodiment, the method may further include generating, by the at least one processor, based on the status information of each of the one or more cards, the second card information from which at least one of the one or more cards issued to the user are excluded.

In an embodiment, the method may further include transmitting, by the at least one processor, password registration-related information before transmitting the second card information to the terminal of the user when the card password is determined not to be set based on the first determination value.

In an embodiment, the transmitting, by the at least one processor, of the card replacement number for the first card to the card company server may be performed so as to transmit the connection information with the card replacement number for the first card.

In an embodiment, the method may further include performing, by the at least one processor, a validity determination operation for the connection information before transmitting the connection information to the card company server with the card replacement number for the first card, wherein the validity determination operation is an operation for determining whether the connection information acquired from the server of the card member store matches the connection information to be transmitted to the card company server.

In an embodiment, the paying for the order by the at least one processor based on the approval information may include transmitting the approval information, the connection information, and the order information to the server of the card member store to pay for the order.

Another aspect of the present disclosure may provide a non-transitory computer-readable recording medium for recording commands performed on a computer in order to support a payment of a user in a card member store. When the commands recorded in the recording medium according to the present disclosure are executed by at least one processor, the at least one processor may acquire, from a server of the card member store, connection information generated based on a resident registration number of the user and order information for an order of the user, may transmit the connection information to a card company server, may acquire first card information of the user determined based on the connection information from the card company server, the first card information including one or more card replacement numbers, each of the one or more card replacement numbers being a value generated based on a card number of each of one or more cards issued to the user, and the card number of each of the one or more cards being a value stored in the card company server at a time point of issuing of each of the one or more cards, may transmit second card information generated based on the first card information to a terminal of the user, may acquire, from the terminal of the user, information indicating a first card used to pay for the order among one or more cards included in the second card information, may transmit a card replacement number for the first card to the card company server, may acquire, from the card company server, approval information for approving payment for the order by the first card, and may pay for the order based on the approval information.

### BRIEF DESCRIPTION OF DRAWINGS

The accompanying drawings, which are incorporated in and constitute a part of the specification, illustrate embodiments of the present disclosure.

FIG. 1 illustrates a process of transmitting/receiving data between multiple devices according to an embodiment of the present disclosure.

FIG. 2 is a block diagram of a payment support device according to an embodiment of the present disclosure.

FIG. 3 is a flowchart illustrating a payment support method according to an embodiment of the present disclosure.

FIG. 4 is an operation flowchart of a payment support device according to an embodiment of the present disclosure.

### DETAILED DESCRIPTION

Various embodiments described herein are exemplified for the purpose of clearly explaining the technical idea of the present disclosure, and are not intended to limit the present disclosure to specific embodiments. The technical idea of the present disclosure includes various modifications, equivalents, and alternatives of each embodiment described herein, and embodiments selectively combined from all or a part of each embodiment. In addition, the scope of the rights of the technical idea of the present disclosure is not limited to various embodiments presented below or detailed description thereof.

All terms, including technical or scientific terms, used herein have meanings that are generally understood by those skilled in the art to which the present disclosure pertains, unless otherwise specified.

Expressions used herein, such as “include,” “may include,” “provided with,” “may be provided with,” “have,” etc., mean that target features (e.g., a function, an operation, an element, etc.) exist, and do not exclude the existence of other additional features. That is, such expressions should be understood as open-ended terms connoting the possibility of inclusion of other embodiments.

A singular expression used herein can include meanings of plurality, unless otherwise mentioned in the context, and the same is applied to a singular expression stated in the claims.

The terms “first,” “second,” “the first,” the “second,” etc. used herein are used to distinguish one object from another object in indicating a plurality of homogeneous objects, unless otherwise specified in the context, and are not intended to limit the order or importance of the relevant objects.

Expressions, such as “A, B, and C,” “A, B, or C,” “A, B, and/or C,” “at least one of A, B, and C,” “at least one of A, B, or C,” or “at least one of A, B, and/or C,” used herein may mean each listed item or all possible combinations of listed items. For example, “at least one of A or B” may refer to all of (1) at least one A, (2) at least one B, and (3) at least one A and at least one B.

The term “unit” used herein means a software element or a hardware element, such as a field-programmable gate array (FPGA) or an application specific integrated circuit (ASIC). However, a “unit” is not limited to software and hardware. The “unit” may be configured to be in an addressable storage medium or may be configured to run on one or more processors. For example, a “unit” may include elements, such as software elements, object-oriented software elements, class elements, and task elements, as well as processors, functions, attributes, procedures, subroutines, segments of program codes, drivers, firmware, micro-codes, circuits, data, databases, data structures, tables, arrays, and variables.

The expression “based on” used herein is used to describe one or more factors that influence a decision, an action of judgment, or an operation described in a phrase or sentence including the relevant expression, and this expression does not exclude an additional factor influencing the decision, the action of judgment, or the operation.

When a certain element (e.g., a first element) is expressed as being “coupled to” or “connected to” another element (e.g., a second element), this means that the certain element may be coupled or connected directly to the other element or that the certain element may be coupled or connected to the other element via another new element (e.g., a third element).

The expression “configured to” used herein may have a meaning such as “set to,” “having the capacity to,” “adapted to,” “made to,” or “capable of” according to the context. The relevant expression is not limited to a meaning of “specifically designed to” in hardware. For example, a processor configured to perform a specific operation may mean a special purpose computer structured through programming so as to perform the specific operation.

Hereinafter, various embodiments of the present disclosure will be described with reference to the accompanying drawings. In the accompanying drawings and the description of the drawings, identical or substantially equivalent elements are assigned with identical reference numerals. Furthermore, in the following description of various embodiments, repeated descriptions of the identical or relevant elements will be omitted. However, this does not mean that such elements are not included in the embodiments.

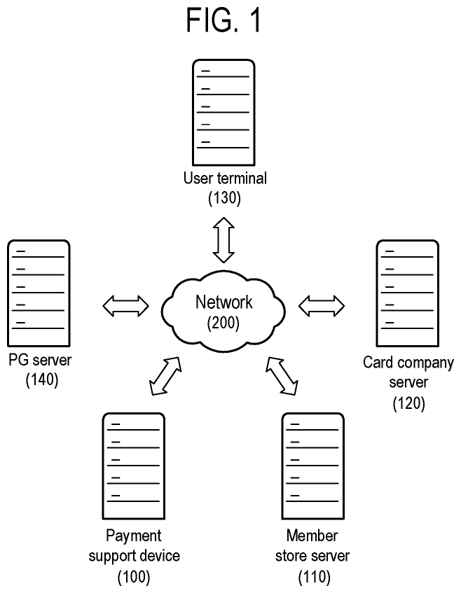

FIG. 1 illustrates a process of transmitting/receiving data between multiple devices according to an embodiment of the present disclosure. In order to provide a payment support technology according to the present disclosure, a payment support device (payment support apparatus) 100 may be provided. The payment support device 100 may be a service provider server for providing a service (e.g., OO pay) according to a payment support technology of the present disclosure. The payment support device 100 according to the present disclosure may acquire predetermined data through communication using a network 200 together with at least one other device 110, 120, 130, or 140. The payment support device 100 may exchange information with a member store server 110, a card company server 120, a user terminal 130, and/or a payment gateway (PG) server 140. The payment support device 100 may transmit/receive data to/from the user terminal 130, thereby providing a screen for payment support to the user terminal 130. The screen may include a graphic element such as a user interface (UI). The payment support device 100 may provide the screen to a user through a webpage or a predetermined program (e.g., an application) installed in the user terminal 130.

In the present disclosure, the member store server 110 may be a server of a member store which is a payment place. Here, the member store may mean a company affiliated with a service provider and/or a card company in order to provide payment support technology. Any company, such as an electronic commerce company (e.g., Internet shopping mall), capable of functioning as a card payment place may become a member store. The member store may be called a partner company.

In the present disclosure, the card company server 120 may be a server of a card company which has issued, to a user, cards (including all payment means such as a check card and a mobile credit card) which are payment means in the payment support technology of the present disclosure.

In the present disclosure, the user terminal 130 may be a terminal for making a payment that is used by a user (a customer) desiring to pay. For example, the user terminal may be a portable communication device (e.g., a smartphone), a computer device (e.g., a tablet PC and a laptop), a portable multimedia device, a wearable device, or a device according to a combination of the above-mentioned devices. The user may access, through the user terminal, a webpage providing the payment support technology of the present disclosure, or may execute a program (e.g., an application) installed in the user terminal so as to provide the payment support technology.

In the present disclosure, the PG server 140 may be a server configured to process requested payment to approve or refuse the payment. The PG server 140 may be referred to as a “payment server.” Hereinafter, depending on the context, the card company server 120, the member store server 110, and the PG server 140 may be referred to as a card company, a member store, and a PG, respectively. The multiple devices illustrated in FIG. 1 are merely examples for description, and the payment support device 100 may exchange data with more or fewer devices as necessary in order to provide the payment support technology.

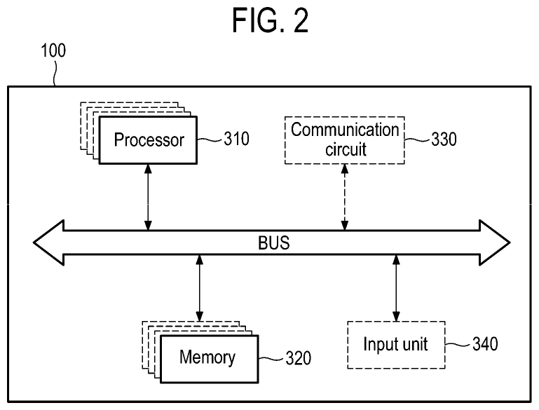

FIG. 2 is a block diagram of a payment support device 100 according to an embodiment of the present disclosure. The payment support device 100 may be the above-mentioned payment support device. In an embodiment, the payment support device 100 may include at least one processor 310 and/or at least one memory 320 as elements. In an embodiment, at least one of the elements of the payment support device 100 may be omitted, or another element may be added to the payment support device 100. In an embodiment, additionally or alternatively, some elements may be integrally implemented, or may be implemented as a single entity or multiple entities. In the present disclosure, the at least one processor 310 may be expressed as the processor 310. The processor 310 may mean a set of one or more processors, unless clearly expressed otherwise in the context. In the present disclosure, the at least memory 320 may be expressed as the memory 320. The memory 320 may mean a set of one or more memories, unless clearly expressed otherwise in the context. In an embodiment, at least some elements of elements inside/outside the payment support device 100 may be connected to one another through a general purpose input/output (GPIO), a serial peripheral interface (SPI), or a mobile industry processor interface (MIPI) so as to exchange information (data, signals, etc.) with one another.

The processor 310 may drive software (e.g., a command, a program, etc.) to control at least one element of the payment support device 100 connected to the processor 310. Further, the processor 310 may perform operations, such as various calculations, processing, data generation, processing, etc. related to the present disclosure. Furthermore, the processor 310 may load data, etc. from the memory 320, or may store the data, etc. in the memory 320.

The memory 320 may store various types of data. The data stored in the memory 320 may be data which is acquired, processed, or used by at least one element of the payment support device 100, and may include software (e.g., a command, a program, etc.). The memory 320 may include volatile and/or non-volatile memory. In the present disclosure, a command or a program is software stored in the memory 320, and may include an operating system for controlling resources of the payment support device 100, an application, and/or middleware for providing various functions to the application such that the application can use the resources of the payment support device 100. In an embodiment, the memory 320 may store commands which, when executed by the processor 310, cause the processor 310 to perform operations. In an embodiment, the processor 310 may control a communication circuit 330 to acquire information from another server or another device. The acquired information may be stored in the memory 320. In an embodiment, the memory 320 may store connection information, order information, first card information, second card information, approval information, etc., which will be described later.

In an embodiment, the payment support device 100 may further include the communication circuit 330. The communication circuit 330 may be omitted in the payment support device 100 depending on embodiments. The communication circuit 330 may perform wireless or wired communication between the payment support device 100 and another server/device. For example, the communication circuit 330 may perform wireless communication according to enhanced Mobile Broadband (eMBB), Ultra Reliable Low-Latency Communications (URLLC), Massive Machine Type Communications (MMTC), Long-Term Evolution (LTE), LTE Advance (LTE-A), New Radio (NR), Universal Mobile Telecommunications System (UMTS), Global System for Mobile communications (GSM), Code Division Multiple Access (CDMA), Wideband CDMA (WCDMA), Wireless Broadband (WiBro), Wireless Fidelity (WiFi), Bluetooth, Near Field Communication (NFC), Global Positioning System (GPS), or Global Navigation Satellite System (GNSS). For example, the communication circuit 330 may also perform wired communication according to schemes such as Universal Serial Bus (USB), High Definition Multimedia Interface (HDMI), Recommended Standard-232 (RS-232), or Plain Old Telephone Service (POTS). The communication circuit 330 may access the network 200 in FIG. 1 to communicate with multiple different devices. The payment support device 100 may exchange information with the member store server 110, the card company server 120, the user terminal 130, and/or the PG server 140 through the communication circuit 330. In an embodiment, the payment support device 100 may be implemented by being integrated with another device (e.g., a card company server). In this case, the communication circuit 330 may function as a connection circuit or an interface for connecting the payment support device 100 to the other device. In an embodiment, the payment support device 100 may be various types of devices. For example, the payment support device 100 may be the above-mentioned server (i.e., a computing device) or a chip, a board, a circuit, etc. in the device.

In an embodiment, the payment support device 100 may further include an input unit 340. The payment support device 100 may receive a user input through the input unit 340. The input unit 340 may include keys and/or buttons on a user interface (UI) for receiving a user input, or physical keys and/or buttons. The input unit 340 according to embodiments of the present disclosure may sense button manipulation or touch input by a user to receive a signal, or may receive the user's motion or voice through a camera or a microphone and may convert the same into an input signal. The input unit 340 according to embodiments of the present disclosure may be implemented as an external input device connected to the payment support device 100. For example, the external input device may be at least one among a touch pen, a keyboard, a mouse, or a touch pad for receiving a user input. The input unit 340 according to an embodiment of the present disclosure may recognize a user touch input. The input unit 340 may be formed as a touch screen configured to receive a user's selection input. For the touch screen, any one of a contact capacitive method, an infrared light sensing method, a surface acoustic wave (SAW) method, a piezoelectric method, and a resistive film method may be used. The detailed description of the touch screen is merely an example according to an embodiment of the present disclosure, and the input unit 340 including various touch screens may constitute the payment support device 100.

The elements of the payment support device 100, described above with reference to FIG. 2, may be identically or similarly included in the member store server 110, the card company server 120, the user terminal 130, and/or the PG server 140. Further, some of the elements in FIG. 2 may be omitted, or a new element may be added.

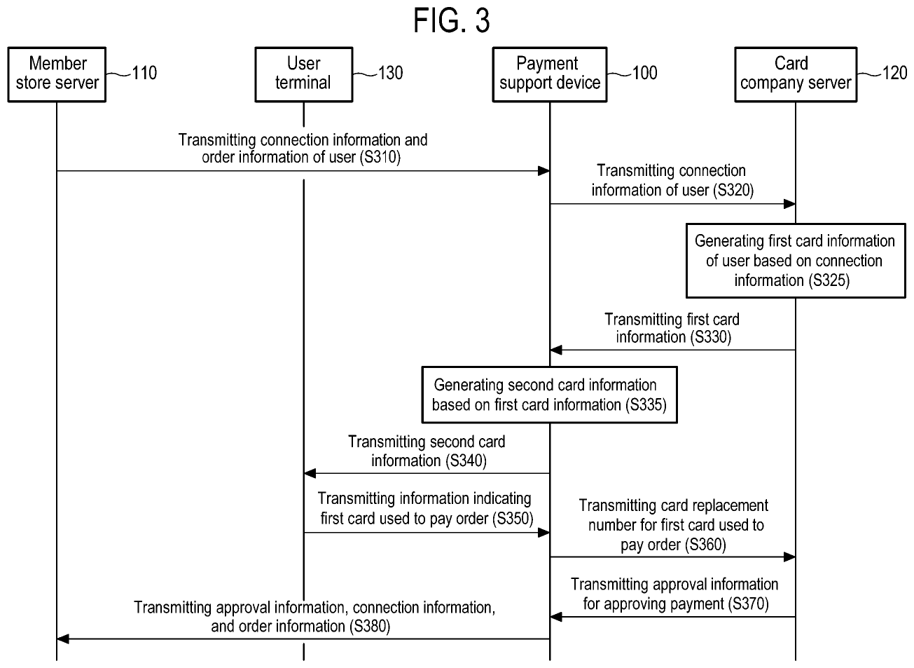

FIG. 3 is a flowchart illustrating a payment support method according to an embodiment of the present disclosure. In step S310, the processor 310 of the payment support device 100 may acquire, from the member store server 110, order information and/or connection information generated based on a resident registration number of a user. The connection information according to the present disclosure may be information uniquely assigned to the user. At this time, the connection information being “uniquely assigned” to each user may mean that the connection information is assigned as a single value to each user, regardless of the existence of multiple different servers on a communication network. According to the present disclosure, a single piece of connection information may be assigned to each user, and thus the multiple servers present on the communication network may identify a specific subject without a separate operation process (e.g., a personal information comparison operation based on ID) for identifying whether at least two users are identical subjects. The connection information according to the present disclosure may be information generated to correspond one-to-one to the resident registration number of the user. The resident registration number is a value uniquely assigned to each user, and connection information generated based on the resident registration number may be unique information which exists as the only one for each user. The resident registration number may be, for example, a Social Security Number (SSN) or a Taxpayer Identification Number (TIN). The connection information may be, for example, a “Connecting Information (CI)” value. The order information according to the present disclosure may include information about a product or service ordered by the user. For example, the order information may include information indicating a product name, the number of products, payment data and time, payment amount, etc. The order information may be acquired from all companies functioning as payment places such as an electronic commerce company.

In step S320, the processor 310 of the payment support device 100 may transmit the connection information to the card company server 120. In an embodiment, after performing step S310 and before performing step S320, a terms and conditions agreement procedure or an identity authentication procedure may be performed. The payment support device 100 may perform the terms and conditions agreement procedure or the identity authentication procedure through mobile phone SMS authentication in a user's name, and in this process, the processor 310 may transmit the connection information to the card company server 120 to acquire the user's phone number stored in the card company server 120, and may use the user's phone number for the identity authentication procedure. In an embodiment, the terms and conditions agreement procedure or the identity authentication procedure, described above, may be performed only once for the first time for each user.

In step S325, the card company server 120 may inquire (i.e., look-up), based on the connection information, at least one card issued in the name of the user in a card company database. The card company server 120 may generate, based on the inquired card (i.e., the looked-up card), a first card information for the user. The first card information may include one or more card replacement numbers. The card replacement numbers may be values generated based on card numbers of cards issued to the user. Each of the one or more card replacement numbers may be a value generated based on a card number of each of one or more cards issued to the user. The card number of each of the one or more cards may be a value stored in the card company server 120 at the time of issuing of each of the one or more cards. The card replacement numbers may correspond one-to-one to card numbers of actually issued cards. Each of the card replacement numbers may be expressed by a predetermined number having the same digits as a corresponding card number, or may be expressed a number irrelevant to the corresponding card number.

According to an embodiment, the one or more card replacement numbers may be values generated by encoding card numbers of the one or more cards. For example, the card company server 120 may use at least one secret key value to perform an operation for a card number, thereby generating a card replacement number. The at least one secret key value may be individually managed in the card company server. The operation for generating a card replacement number by applying a secret key value to a card number may include, for example, arithmetic operations, a logical operation (e.g., OR, AND, XOR, etc.), a bitwise shift operation, etc. The operation for generating a card replacement number from a card number may be an operation in which a reverse calculation is possible. That is, the card company server 120 may encode a card number to generate a card replacement number, and may decode the card replacement number to recover the card number.

According to an embodiment, each of the one or more card replacement numbers may be a value generated based on a card number of each of one or more cards issued to the user with reference to a time point at which the payment support device 100 transmits the connection information to the card company server 120. As described, the connection information may be information which uniquely exists for one user on a communication network. Therefore, the card company server 120 may inquire one or more cards issued to the user with reference to a time point at which the connection information is received from the payment support device 100. The card company server 120 may inquire, based on the connection information, one or more cards issued in the name of the user, and may generate a card replacement number corresponding to each of the one or more cards.

By inquiring the one or more cards issued to the user with reference to a time point at which the payment support device 100 transmits the connection information to the card company server 120, the payment support device 100 may identify all cards in the user's name from a card company which is a card issuer, regardless of whether the user has registered the user's cards with a separate service subject (e.g., a payment service providing company or a payment service brokerage company). For example, in a case where the card company server and the server (i.e., the payment support device) for supporting payment as in the present disclosure do not integrate and manage card-related information of the user by using the connection, the user should go through a separate card registration or identity authentication procedure, regardless of whether the card company has issued a card, card information stored in the card company server, etc. Such a card registration procedure, etc. may cause user inconvenience and waste of operation resources of the server. Furthermore, when a card previously registered with a payment service provider cannot be used for a certain reason (e.g., cancellation, suspension, loss, etc.), a discrepancy occurs between the actual state of the user's card stored in the card company server and the status of the card stored in a server of the payment service provider until the user performs an operation of directly notifying the payment service provider of the impossibility of using the card (e.g., accesses the payment service provider and deletes the registered card). During payment for a product or a service, when the payment process is delayed or complicated due to a problem with the previously registered card, there is a problem in that a customer may defect. By contrast, according to the present disclosure, with reference to a time point at which the payment support device 100 transmits the connection information to the card company server 120, the payment support device 100 may directly acquire, from the card company, first card information about one or more cards issued to the user, and thus the above-mentioned problem may be resolved.

In an embodiment, the first card information may further include at least one among status information of each of the one or more cards issued to the user, card image information of each of the one or more cards, and a first determination value for indicating whether a card password is set.

In an embodiment, the status information of each of the one or more card included in the first card information may be information indicating a current status of the card. For example, the status of a card includes normality, extinction due to period expiration, extinction due to cancelation, suspension due to loss, etc., and status information of each card may include a numerical value corresponding to the state of each of the above-mentioned cards. That is, the status information may indicate the status of a card as “1” when the status of the card in normal, “2” when the card expires due to expiration of the period, and the like.

In an embodiment, the card image information of each of the one or more cards included in the first card information may include image data for displaying a card plate in various electronic devices by a predetermined method. The image data may be data having file formats, for example, jpg, jpeg, gif, png, bmp, etc. Furthermore, the card image information of each of the one or more cards may be a card image code corresponding to a card image. For example, when the name of plate image data of a specific card is “H.jpg”, the card company server 120 may generate the first card information by including an image code (e.g., H) corresponding to the image data, other the image data, in the first card information. In the present embodiment, a description has been made of an example in which the name of card image data is used as an image code as it is, but regardless thereof, each of image data may be mapped to a specific code, thereby generating the first card information. As described above, when a card image code is used as the card image information, the payment support device 100 may use an image code received from the card company server 120 to utilize a corresponding image among card images pre-stored in the memory 320 of the payment support device 100. As a result, the card company server 120 may generate/transmit the first card information by using a relatively small number of bits, and the payment support device 100 may also receive data having a relatively small size (i.e., the first card information). Therefore, there is an advantageous effect of reducing a communication burden for loading.

In an embodiment, the first determination value, which indicates whether a card password is set and which is included in the first card information, may have two different values depending on whether the password is set. For example, when the password is set, the first determination value may be “1”, and, when the password is not set, the first determination value may be “0”. The first determination value may be configured as a single value for all cards. At this time, the first determination value may be “0” when a password is not set for all cards, and may be “1” when a password is set for any one of all cards. Further, the first determination value may be individually present for each of all cards, and each card may have a value of “0” when the password is not set and may have a value of “1” when the password is set.

In step S330, the card company server 120 may transmit the generated first card information to the payment support device 100. The processor 310 of the payment support device 100 may control the communication circuit 330, etc. to acquire the first card information of the user from the card company server 120.

In step S335, the processor 310 of the payment support device 100 may generate second card information based on the first card information. The second card information may include only information about a card, by which payment can be currently made, i.e., a valid card, among multiple cards included in the first card information. When card image information included in the first card information is card image codes, the second card information may be information including card image data that matches each card image code.

In an embodiment, the processor 310 may generate, based on the status information of each of one or more cards included in the first card information, the second card information including only information about cards other than at least some of one or more cards issued to the user. For example, the first card information may also include information about a currently invalid card among cards issued to the user. The processor 310 may check the status information of each of the one or more cards to exclude a card by which payment cannot be made, and may generate the second card information including only information about the other cards. According to the above-mentioned content of the present disclosure, information about cards issued to the user may be acquired in real time from the card company server by using the connection information, and the cards may be displayed after exclusion of a card unusable for payment, thereby preventing the unusable card from being displayed on the user terminal 130 and selected by the user.

In step S340, the processor 310 of the payment support device 100 may transmit the second card information to the user terminal 130. In an embodiment, the processor 310 may determine, based on the first determination value included in the first card information, whether the card password is not set. When it is determined that the card password is not set, the processor 310 may transmit password registration-related information to the user terminal 130 before transmitting the second card information to the user terminal 130. The password registration-related information may include web/application screen information for password registration, a homepage link for password registration, etc. The password registration-related information may further include a phone number of a card company customer center. For example, when a password is not set for each card held by a user, a first determination value included in the first card information of the user may be “0”. In this case, the processor 310 may identify a value of “0”, and may transmit password registration-related information to the user terminal 130. The present disclosure has the effect of forcing card password configuration through the first determination value as described above, and thus may prevent an erroneous touch, malfunction, or unauthorized payment by other persons on the user terminal.

In step S350, the user terminal 130 may transmit, to the payment support device 100, information indicating a first card used to pay for the order, among one or more cards included in the second card information. Therefore, the processor 310 of the payment support device 100 may acquire the information indicating the first card used to pay for the order.

In an embodiment, the user terminal 130 may indicate, based on predetermined various indication methods, the first card used to pay for the order among the one or more cards included in the second card information. In one example, the user terminal 130 may indicate, as the first card, a card which is first on a card list of the one or more cards included in the second card information. In another example, the user terminal 130 may indicate the first card, based on an input signal according to a user's selection. For example, the user may see, through a display unit of the user terminal 130, a user interface screen based on the second card information received from the payment support device 100. At this time, the user may select, through an input unit, the first card used to pay for the order among one or more cards displayed on the user interface screen. The input unit of the user terminal 130 may have a configuration identical or similar to that of the above-mentioned input unit 340 of the payment support device 100. The user terminal 130 may indicate, based on the input signal according to the user's selection, the first card used to pay for the order among the one or more cards included in the second card information, and may transmit information indicating the first card to the payment support device 100.

The payment support device 100 may acquire, from the user terminal 130, the information indicating the first card used to pay for the order, and may additionally acquire a payment password. The payment password acquired from the user terminal 130 may be an actual password, which is stored in the card company server 120, of the first card used to pay for the order, and may be a password irrelevant to the actual password of the first card used to pay for the order. When the payment password acquired from the user terminal is irrelevant to the actual password of the first card used to pay for the order, the payment password may be an authentication password managed only in the payment support device 100. Further, whether the payment support device 100 additionally acquires a payment password may be determined based on an order amount included in the order information. For example, only when the order amount is larger than a predetermined amount (e.g., fifty thousand won), the payment support device may additionally acquire a payment password from the user terminal and may determine whether to continue the payment process.

In step S360, the processor 310 of the payment support device 100 may transmit a card replacement number for the first card to the card company server 120. As described above, the first card may be a card used to pay for a target order. In an embodiment, when it is determined that the payment support device 100 will additionally acquire a payment password form the user terminal 130, the payment support device 100 may transmit the card replacement number for the first card to the card company server 120 only when the payment password received from the user terminal is normally authenticated.

Further, in step S360, the processor 310 may transmit the connection information to the card company server 120 with the card replacement number for the first card. At this time, the card company server 120 may compare the connection information, which was transmitted together with the card replacement number for the first card, with the connection information, which was transmitted in the previous step of the payment process, to verify matching therebetween. When the types of the connection information transmitted at two different time points are different from each other, the card company server 120 may not approve the payment, and this may reduce the risk of hacking that may occur in the process of data transfer between multiple servers. In an embodiment, before step S360, the processor 310 of the payment support device 100 may perform a validity determination operation for the connection information. The validity determination operation may be an operation for determining whether the connection information acquired from the member store server 110 matches the connection information to be transmitted to the card company server 120. The processor 310 may directly perform the validity determination operation for determining whether the two types of connection information match each other, thereby preventing illegal payment while reducing the processing burden of the card company server 120.

In step S370, when the card replacement number for the first card is received, the card company server 120 may generate approval information for approving the payment by the first card, and may transmit the approval information to the payment support device 100. The processor 310 of the payment support device 100 may acquire the approval information. The processor 310 may perform payment for a target order, based on the acquired approval information. The approval information may be one-time information for approval of card payment. The approval information may be one-time information generated based on information such as a card number, information about a member store as a payment place, payment date and time, a payment amount, etc. In one example, the approval information may be information of a one-time communication (OTC) token type. The approval information may be transferred to the PG server 140 through the member store server 110, thereby allowing actual payment to be made.

In step S380, the processor 310 of the payment support device 100 may transmit the approval information, the connection information, and/or the order information to the member store server 110 so that the member store server 110 can perform payment for the user's order. In an embodiment, the member store server 110 may verify, once more, whether the user is the same subject, through the connection information transmitted together with the approval information and the order information.

Thereafter, the member store server 110 may determine whether the payment amount, for which a request is made to the user through the order information and the approval information, is properly paid, and then may make a request to the PG server 140 for the payment. Therefore, the PG server 140 may finally process the payment requested from the user so that the transaction is concluded between the card company server 120 and the member store server 110.

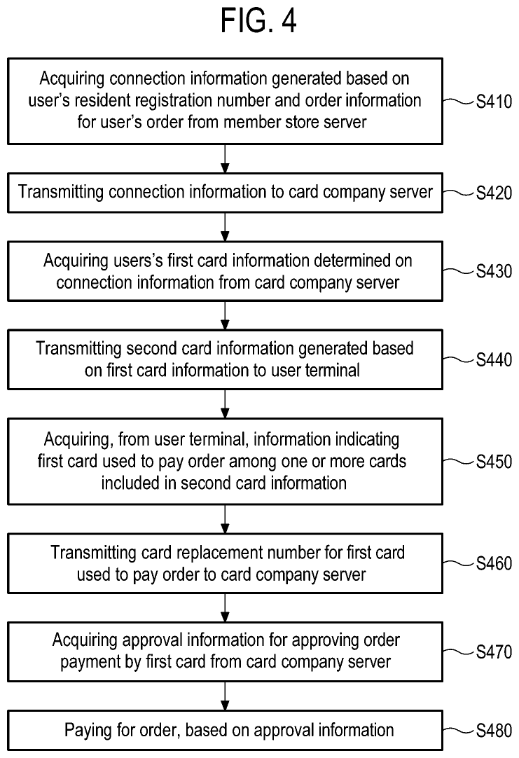

FIG. 4 is an operation flowchart of the payment support device 100 according to an embodiment of the present disclosure. In operation S410, the payment support device 100 may acquire, from the member store server 110, connection information generated based on a resident registration number of a user and order information for the user's order. At this time, the connection information is a value commonly used by multiple servers present on a network, and may be information uniquely assigned to each user. The order information may include predetermined information for product purchase, such as a product name, a product amount, payment date and time, payment amount, etc.

In operation S420, the processor 310 of the payment support device 100 may transmit the connection information to the card company server 120. The processor 310 of the payment support device 100 may perform, before performing operation S420, terms and conditions agreement or identity authentication for the user. The terms and conditions agreement and the identity authentication may be performed only once for the first time for the user.

In operation S430, the payment support device 100 may acquire, from the card company server 120, first card information of the user determined based on the connection information. The payment support device 100 according to the present disclosure may inquire card-related information of the user by using the connection information which is unique to the user and can be commonly used by multiple servers. Therefore, there is an advantage of eliminating the inconvenience of the user of having to register the card for each of the multiple servers or a waste of a storage space and reflecting, in real time, the existing status of cards managed by the card company. Further, a separate procedure of requesting card registration may be omitted by using the connection information, and thus the time and procedure required for payment may be reduced.

In operation S440, the processor 310 of the payment support device 100 may transmit second card information generated based on the first card information to the user terminal 130. The payment support device 100 may generate the second card information after receiving the first card information from the card company server 120. The payment support device 100 may generate the second card information by using at least one among status information of each of one or more cards, card image information of each of the one or more cards, and a first determination value indicating whether a card password is set, which are included in the first card information. For example, the payment support device 100 may determine the status information of each card and, when the card is not valid, may exclude the card and may generate the second card information to be transmitted to the user terminal 130.

In operation S450, the payment support device 100 may acquire, from the user terminal 130, information indicating a first card used to pay for the order among one or more cards included in the second card information. Indicating the first card among the one or more cards included in the second card information may be performed by the user terminal 130 through a predetermined method. As an example, the user terminal 130 may indicate, as the first card, a card which is at the top of a list of the one or more cards included in the second card information. As another example, the user terminal 130 may indicate a card used for latest payment as the first card. As another example, the user terminal 130 may also indicate the first card based on an input signal of the user that is input through an input unit of the user terminal 130.

In operation S460, the processor 310 of the payment support device 100 may transmit, to the card company server 120, a card replacement number for the first card used to pay for the order. The card company server 120 may receive the transmitted card replacement number for the first card used to pay for the order and may generate approval information for approving the payment by the card. The approval information may be one-time information for approving a single transaction, and may have, for example, the form of an OTC token.

In operation S470, the payment support device 100 may acquire, from the card company server 120, the approval information for approving the payment of the order using the first card. Thereafter, in operation S480, the processor 310 of the payment support device 100 may perform payment for the user's order, based on the approval information. The processor 310 of the payment support device 100 may transmit the approval information to the member store server 110, and may request the member store server 110 to transmit the approval information to the PG server 140. As a result, the member store server 110 may determine whether a correct amount of payment has been made and whether the user is the same, and may finally report the transaction to the PG server 140. Thereafter, the PG server 140, which is a medium between the card company server 120 and the member store server 110, may finally record conclusion of the transaction.

In each flowchart illustrated in the present disclosure, the steps of the method or algorithm according to the present disclosure have been sequentially described. However, in addition to being sequentially performed, the steps may be performed in an order in which the steps may be randomly combined by the present disclosure. The description according to the present flowcharts does not exclude making changes or modifications of the method or the algorithm, and does not mean that any step is essential or desirable. In an embodiment, at least some steps may be performed in parallel, repeatedly, or heuristically. In an embodiment, at least some steps may be omitted, or another step may be added.

According to the conventional payment service (hereinafter, “comparison service”), a user must go through the process of registering a card to be used with the comparison service, regardless of receiving the card from a card company. That is, the user must register the card to be used with the comparison service company which does not share whether the card has been issued (i.e., generated). Furthermore, in the process in which the user orders and pays for a product at a member store, when the user selects payment using the comparison service, a server of the member store transmits order information (including payment amount information) to a comparison service server, and the user logs in the comparison service and specifies one of cards registered in the comparison service server to make payment. Therefore, from the point of view of the user using the comparison service, there is an inconvenience of having to register a card regardless of issuance of the card in order to use a payment service. When the card is not registered, the user cannot select the card in a payment process. Furthermore, even when the card cannot be currently used, the payment process continues in the comparison service in which the corresponding fact is not shared, resulting in an error in the payment process.

In contrast, according to the payment service (hereinafter, “payment support service”) of the present disclosure, when there is a user's order, the payment support device 100 may receive information about a card from the card company server 120 through the connection information, and thus the user need not register information about the user's card with a server for the payment support service. Further, multiple subjects including the member store server 110, the payment support device 100, the card company server 120, etc. may share connection information to specify a user, and thus the user need not perform a procedure for authenticating the user in the payment process two or more times. In addition, when there is the user's order, the payment support device 100 may receive, using the connection information, information about a card issued to the user from the card company server 120 in real time, and thus may omit unnecessary operations, such as an operation which determines whether a registered card is valid and which is repeatedly performed in a device for performing the comparison service, and as a result, may reduce an operation burden. Furthermore, the user need not manually delete an invalid card from the payment support service.

Therefore, according the payment service of the present disclosure, the user may omit a separate card registration procedure or log-in procedure for using the payment support service, thereby eliminating the inconvenience. Further, the process of information exchange between devices may be simplified, and thus an operation burden on the entire system may be reduced. Furthermore, the payment support device 100 of the present disclosure, unlike the device for performing the comparison service, need not go through a periodic update process with a card issuing subject (e.g., a card company server) or the user terminal 130, and thus the operation burden may be reduced.

According to various embodiments of the present disclosure, it is possible to provide a technology for supporting a user's payment through data processing between multiple devices.

According to various embodiments of the present disclosure, payment is supported using connection information, and it is thus possible to reduce a payment procedure required for a user. That is, it is possible to simply and quickly support payment while reducing the burden of the user having to separately manage a card in addition to being issued with the card from a card company.

According to various embodiments of the present disclosure, in connection with supporting the user's payment, it is possible to further reduce an operation burden in a user terminal. In general, a user terminal (e.g., a smartphone) designed in consideration of portability may have lower operation performance than a computing system such as a server. In consideration thereof, the payment support technology according to the present disclosure is capable of minimizing operations in the user terminal and allowing most of the operations to be performed in the server. For example, the user terminal does not need to separately participate in a card registration procedure, and thus the operation burden of the user terminal may be reduced.

Various embodiments of the present disclosure may be implemented as software in a machine-readable storage medium. The software may be software for implementing various embodiments of the present disclosure. The software may be inferred from various embodiments of the present disclosure by programmers in a technical field to which the present disclosure belongs. For example, the software may be a program including a machine-readable instruction (e.g., a code or a code segment). A machine may be a device capable of operating according to an instruction called from the storage medium and may be, for example, a computer. In an embodiment, the machine may be the computing device (payment support device) 100 according to embodiments of the present disclosure. In an embodiment, a processor of the machine may execute a called instruction to cause elements of the machine to perform a function corresponding to the instruction. In an embodiment, the processor may be the processor 310 according to embodiments of the present disclosure. The storage medium may mean any type of recording medium in which data capable of being read by the machine is stored. The storage medium may include, for example, a ROM, a RAM, a CD-ROM, a magnetic tape, a floppy disk, an optical data storage device and the like. In an embodiment, the storage medium may be the memory 320. In an embodiment, the storage medium may be distributed to computer systems which are connected through a network. The software may be stored and executed in a distributed manner in the computer systems. The storage medium may be a non-transitory storage medium. The non-transitory storage medium means a tangible medium in which data is stored semi-permanently or temporarily, and does not include a transitorily propagated signal.

Although the technical idea of the present disclosure has been described through various embodiments, the technical idea of the present disclosure includes various substitutions, modifications, and changes which may be made within a range that can be understood by those skilled in the art to which the present disclosure belongs. Furthermore, it is to be understood that such substitutions, modifications, and changes may fall within the scope of the accompanying claims.

What is claimed is:

1. An apparatus for supporting a payment of a user in a card member store, the apparatus comprising:
at least one processor; and
at least one memory configured to store commands which, when executed by the at least one processor, cause the at least one processor to perform an operation,
wherein the at least one processor is configured to, according to the commands, to perform:
acquire, from a server of the card member store, connection information generated based on a resident registration number of the user and order information for an order of the user,
transmit the connection information to a card company server,
acquire first card information of the user determined based on the connection information from the card company server, the first card information including one or more card replacement numbers, each of the one or more card replacement numbers being a value generated based on a card number of each of one or more cards issued to the user, and the card number of each of the one or more cards being a value stored in the card company server at a time point of issuing of each of the one or more cards,
transmit second card information generated based on the first card information to a terminal of the user,
acquire, from the terminal of the user, information indicating a first card used to pay for the order among one or more cards included in the second card information,
transmit a card replacement number for the first card to the card company server,
acquire, from the card company server, approval information for approving payment for the order by the first card, and
pay for the order based on the approval information.

2. The apparatus of claim 1, wherein the connection information is information uniquely assigned to the user.

3. The apparatus of claim 1, wherein the connection information is information generated to correspond one-to-one to the resident registration number of the user.

4. The apparatus of claim 1, wherein each of the one or more card replacement numbers is a value generated based on the card number of each of the one or more cards issued to the user with reference to a time point of transmitting the connection information to the card company server.

5. The apparatus of claim 1, wherein each of the one or more card replacement numbers is a value generated by encoding the card number of each of the one or more cards.

6. The apparatus of claim 1, wherein the first card information further includes at least one among status information of each of the one or more cards, card image information of each of the one or more cards, and a first determination value for indicating whether a card password is set.

7. The apparatus of claim 6, wherein the at least one processor is configured to generate, based on the status information of each of the one or more cards, the second card information from which at least one of the one or more cards issued to the user are excluded.

8. The apparatus of claim 6, wherein the at least one processor is configured to transmit, when the card password is determined not to be set based on the first determination value, password registration-related information before transmitting the second card information to the terminal of the user.

9. The apparatus of claim 1, wherein the at least one processor is configured to transmit the connection information to the card company server with the card replacement number for the first card.

10. The apparatus of claim 9, wherein the at least one processor is configured to perform a validity determination operation for the connection information before transmitting the connection information to the card company server with the card replacement number for the first card, and
wherein the validity determination operation is an operation of determining whether connection information acquired from the server of the card member store matches the connection information to be transmitted to the card company server.

11. The apparatus of claim 1, wherein the at least one processor is configured to transmit the approval information, the connection information, and the order information to the server of the card member store to pay for the order.

12. A method for supporting a payment of a user in a card member store, the method being performed in an apparatus including at least one processor and at least one memory storing commands executed by the at least one processor, the method comprising:
acquiring, by the at least one processor, connection information generated based on a resident registration number of the user and order information for an order of the user from a server of the card member store;
transmitting, by the at least one processor, the connection information to a card company server;
acquiring, by the at least one processor, first card information of the user determined based on the connection information from the card company server, the first card information comprising one or more card replacement numbers, each of the one or more card replacement numbers being a value generated based on a card number of each of one or more cards issued to the user, and the card number of each of the one or more cards being a value stored in the card company server at a time point of issuing of each of the one or more cards;
transmitting, by the at least one processor, second card information generated based on the first card information to a terminal of the user;
acquiring, by the at least one processor, from the terminal of the user, information indicating a first card used to pay for the order among one or more cards included in the second card information;
transmitting, by the at least one processor, a card replacement number for the first card to the card company server;
acquiring, by the at least one processor, approval information for approving payment for the order by the first card from the card company server; and
paying for the order by the at least one processor based on the approval information.

13. The method of claim 12, wherein the connection information is information uniquely assigned to the user.

14. The method of claim 12, wherein the connection information is information generated to correspond one-to-one to the resident registration number of the user.

15. The method of claim 12, wherein each of the one or more card replacement numbers is a value generated based on the card number of each of the one or more cards issued to the user with reference to a time point of transmitting the connection information to the card company server.

16. The method of claim 12, wherein each of the one or more card replacement numbers is a value generated by encoding the card number of each of the one or more cards.

17. The method of claim 12, wherein the first card information further includes at least one among status information of each of the one or more cards, card image information of each of the one or more cards, and a first determination value for indicating whether a card password is set.

18. The method of claim 17, further includes:
generating, by the at least one processor, based on the status information of each of the one or more cards, the second card information from which at least one of the one or more cards issued to the user are excluded.

19. The method of claim 17, further includes:
transmitting, by the at least one processor, password registration-related information before transmitting the second card information to the terminal of the user when the card password is determined not to be set based on the first determination value.

20. The method of claim 12, wherein the transmitting, by the at least one processor, of the card replacement number for the first card to the card company server is performed so as to transmit the connection information with the card replacement number for the first card.

21. The method of claim 20, further includes:
performing, by the at least one processor, a validity determination operation for the connection information before transmitting the connection information to the card company server with the card replacement number for the first card,
wherein the validity determination operation is an operation of determining whether connection information acquired from the server of the card member store matches the connection information to be transmitted to the card company server.

22. The method of claim 12, wherein the paying for the order by the at least one processor based on the approval information comprises transmitting the approval information, the connection information, and the order information to the server of the card member store to pay for the order.

23. A non-transitory computer-readable recording medium for recording commands performed on a computer in order to support a payment of a user in a card member store, wherein when the commands are executed by at least one processor, the at least one processor is configured to:
acquire, from a server of the card member store, connection information generated based on a resident registration number of the user and order information for an order of the user,
transmit the connection information to a card company server,
acquire first card information of the user determined based on the connection information from the card company server, the first card information comprising one or more card replacement numbers, each of the one or more card replacement numbers being a value generated based on a card number of each of one or more cards issued to the user, and the card number of each of the one or more cards being a value stored in the card company server at a time point of issuing of each of the one or more cards,
transmit second card information generated based on the first card information to a terminal of the user,
acquire, from the terminal of the user, information indicating a first card used to pay for the order among one or more cards included in the second card information,
transmit a card replacement number for the first card to the card company server,
acquire, from the card company server, approval information for approving payment for the order by the first card, and
pay for the order based on the approval information.
